(19) United States
(12) Patent Application Publication
(10) Pub. No.: US 2018/0243932 A1
(43) Pub. Date: Aug. 30, 2018

(54) TOUCH SENSOR PANEL AND CUTTING METHOD OF THE SAME

(71) Applicant: DONGWOO FINE-CHEM CO., LTD., Iksan-si (KR)

(72) Inventors: Hodong YOON, Pyeongtaek-si (KR); Sungwoo YU, Seoul (KR); Dongjin SON, Asan-si (KR)

(73) Assignee: DONGWOO FINE-CHEM CO., LTD., Iksan-si (KR)

(21) Appl. No.: 15/907,423

(22) Filed: Feb. 28, 2018

(30) Foreign Application Priority Data
Feb. 28, 2017 (KR) 10-2017-0026740

(51) Int. Cl. B26D 3/08; G06F 3/041; B26D 1/00; G02B 5/30

(52) U.S. Cl. CPC B26D 3/085; G06F 3/041; B26D 1/0006; B26D 2001/0053; G06F 2203/04103; G06F 2203/04102; G02B 5/30

(57) ABSTRACT

The present invention relates to a touch sensor panel using a flexible film substrate and a cutting method of the touch sensor panel. A smooth cut surface can be obtained by cutting in a direction from the flexible film substrate to the touch sensor.

### CROSS REFERENCE TO RELATED APPLICATIONS

This application claims priority based on Korean Patent Application No. 10-2017-0026740, filed Feb. 28, 2017, the content of which is incorporated herein by reference in its entirety.

### TECHNICAL FIELD

The present invention relates to a touch sensor panel and a cutting method of the touch sensor panel. Particularly, the present invention relates to a touch sensor panel which uses a flexible film substrate and a polarizer incorporated therein and a cutting method of the touch sensor panel.

### BACKGROUND ART

There have been attempts to introduce a touch input method into a wider variety of electronic devices while the touch input method is being spotlighted as a next generation input method.

For example, in the case of an electronic device having a touch-type display, an ultra-thin flexible display that achieves ultra-light weight, low power and improved portability has been attracting attention as a next-generation display, and development of a touch sensor applicable to such a display has been desired.

The flexible display is prepared on a flexible substrate and can bend, fold or roll without damage of its properties, and it may be in the form of a flexible LCD, a flexible OLED, electronic paper, etc.

In order to apply a touch input method to a flexible display, a touch sensor is formed on a flexible film substrate, or a touch sensor is formed on a carrier substrate, and then transferred to a film substrate to manufacture a flexible touch sensor panel.

In the case of a touch sensor panel manufactured on a conventional glass substrate, various cutting methods are used. For example, Korean Patent Registration No. 10-1381123 discloses a cutting method of a substrate for a touch panel including a thin plate glass, a coating layer formed on one surface of the thin plate glass, and a protective film attached to another surface of the thin plate glass into cell form, the method comprising a cutting step of cutting from the coating layer to the inward direction of the thin plate glass, the cutting being performed for a part of the thin plate glass based on the thickness of the thin plate glass; and etching step of etching the cut portion of the thin plate glass to expose the protective film; and a punching step of punching the protective film via a hole formed through the cutting and etching steps thereby cutting into cell form.

However, in the case of a flexible touch sensor panel using a film substrate, the etching method as in Korean Patent Registration No. 10-1381123 cannot be used, and in particular, the polishing process of the cross section after cutting is impossible due to the specificity of the film substrate different from the glass substrate. Accordingly, control of the cut surface is an important task.

### DISCLOSURE OF INVENTION

### Technical Problem

An object of the present invention is to provide a method of cutting a touch sensor panel using a flexible film substrate capable of obtaining a smooth cut surface.

Another object of the present invention is to provide a touch sensor panel using a flexible film substrate which has a cut surface free from cracks or peeling of adhesive or pressure sensitive adhesive.

### Technical Solution

According to an aspect of the present invention, there is provided a polarizer integrated touch sensor panel comprising: a touch sensor; a flexible film substrate disposed on a first side of the touch sensor; and a polarizer disposed on a second side of the touch sensor opposing the first side, wherein, when a cut portion of the polarizer integrated touch sensor panel is enlarged 300 times or more, an interior angle between an outer surface of the flexible film substrate and the cut portion is 90 to 170 degrees.

The polarizer integrated touch sensor panel may further comprise an adhesive layer between the touch sensor and the polarizer.

The adhesive layer may be made of a pressure sensitive adhesive (PSA).

The polarizer integrated touch sensor panel may further comprise an adhesive layer or a pressure sensitive adhesive layer between the touch sensor and the flexible film substrate.

According to another aspect of the present invention, a method of cutting a polarizer integrated touch sensor panel is provided, wherein the polarizer integrated touch sensor panel comprises: a touch sensor; a flexible film substrate disposed on a first side of the touch sensor; and a polarizer disposed on a second side of the touch sensor opposing the first side, and wherein cutting is performed by inserting a knife in a direction from the flexible film substrate toward the touch sensor.

The knife may be inserted perpendicularly to an outer surface of the flexible film substrate.

The knife may be formed to have a blade portion having an angle of 30 to 45 degrees.

### Advantageous Effects

According to the touch sensor panel and the cutting method of the touch sensor panel according to the present invention, it is possible to obtain a smooth cut surface without cracks or peeling of adhesive or pressure sensitive adhesive.

### DESCRIPTION OF DRAWINGS

FIG. 1 is a cross-sectional view showing a touch sensor panel and a cutting method of the same according to one embodiment of the present invention.

FIG. 2 is a SEM image of a touch sensor panel which has been cut according to one embodiment of the present invention.

FIG. 3 shows SEM images of experimental examples of the present invention.

FIG. 4 shows SEM images of comparative examples.

### BEST MODE

Hereinafter, preferred embodiments of a touch sensor panel and a cutting method thereof according to the present invention will be described in detail with reference to the accompanying drawings. However, the drawings accompanying the present disclosure are mere examples for describing the present invention, and the present invention is not limited by the drawings. Also, some elements may be exaggerated, scaled-down, or omitted in the drawings for clearer expressions.

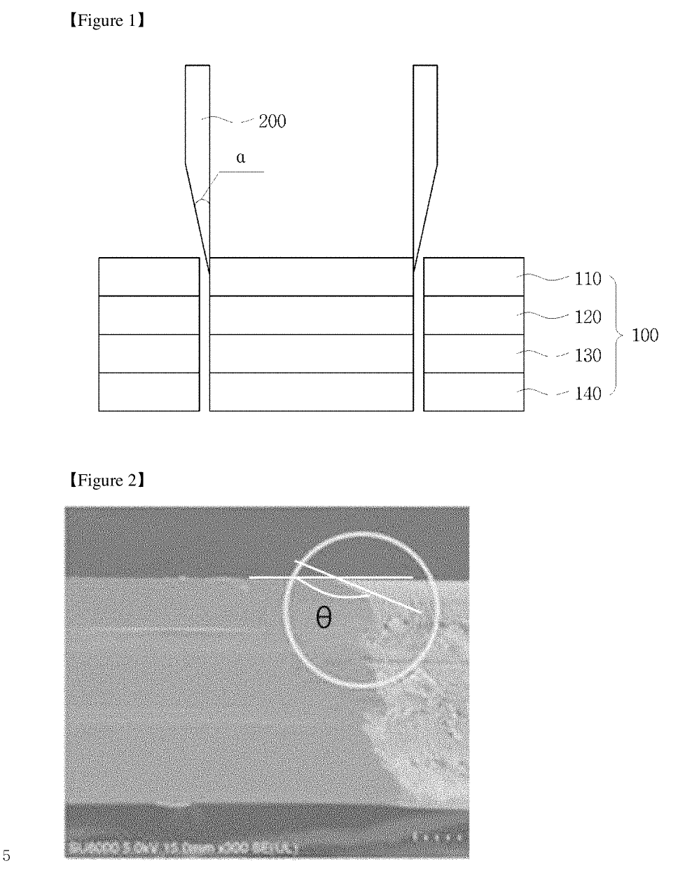

FIG. 1 is a cross-sectional view showing a touch sensor panel and a cutting method of the touch sensor panel according to one embodiment of the present invention.

As shown in FIG. 1, a touch sensor panel according to one embodiment of the present invention comprises a flexible film substrate 110, a touch sensor 120 attached to the flexible film substrate 110, and a polarizer 140 adhered using an adhesive layer 130 to an opposite side of the touch sensor 120 on which the flexible film substrate 110 is attached.

The flexible film substrate 110 may be a transparent film.

The transparent film is not limited if it has good transparency, mechanical strength and thermal stability. Specific examples of the transparent film may include thermoplastic resins, e.g., polyester resins such as polyethylene terephthalate, polyethylene isophthalate, polyethylene naphthalate and polybutylene terephthalate; cellulose resins such as diacetylcellulose and triacetylcellulose; polycarbonate resins; acrylate resins such as polymethyl (meth)acrylate and polyethyl (meth)acrylate; styrene resins such as polystyrene and acrylonitrile-styrene copolymer; polyolefin resins such as polyethylene, polypropylene, polyolefin having a cyclic or norbornene structure, and ethylene-propylene copolymer; vinyl chloride resins; amide resins such as nylon and aromatic polyamide; imide resins; polyethersulfone resins; sulfone resins; polyether ether ketone resins; polyphenylene sulfide resins; vinyl alcohol resins; vinylidene chloride resins; vinyl butyral resins; allylate resins; polyoxymethylene resins; and epoxy resins. Also, a film consisting of a blend of the thermoplastic resins may be used. In addition, thermally curable or UV curable resins such as (meth)acrylate, urethane, acrylic urethane, epoxy and silicon resins may be used.

Such a transparent film may have a suitable thickness. For example, considering workability in terms of strength and handling, and thin layer property, the thickness of the transparent film may range from 1 to 500 μm, preferably 1 to 300 μm, more preferably 5 to 200 μm.

The transparent film may contain at least one suitable additive. Examples of the additive may include an UV absorber, an antioxidant, a lubricant, a plasticizer, a releasing agent, a coloring-preventing agent, an anti-flame agent, an anti-static agent, a pigment and a colorant. The transparent film may comprise various functional layers including a hard coating layer, an anti-reflective layer and a gas barrier layer, but the present invention is not limited thereto. That is, other functional layers may also be included depending on the desired use.

If necessary, the transparent film may be surface-treated. For example, the surface treatment may be carried out by drying method such as plasma, corona and primer treatment, or by chemical method such as alkali treatment including saponification.

Also, the transparent film may be an isotropic film, a retardation film or a protective film.

In the case of the isotropic film, it is preferred to satisfy an in-plane retardation (Ro) of 40 nm or less, preferably 15 nm or less and a thickness retardation (Rth) of −90 nm to +75 nm, preferably −80 nm to +60 nm, particularly −70 nm to +45 nm, the in-plane retardation (Ro) and thickness retardation (Rth) being represented by the following equations.

Ro=[(nx−ny)*d]

Rth=[(nx+ny)/2−nz]*d

wherein, nx and ny are each a main refractive index in a film plane, nz is a refractive index in the thickness direction of film, and d is a thickness of film.

The retardation film may be prepared by uniaxial stretching or biaxial stretching of a polymer film, coating of a polymer or coating of a liquid crystal, and it is generally used for improvement or control of optical properties, e.g., viewing angle compensation, color sensitivity improvement, light leakage prevention, or color control of a display.

The retardation film may include a half-wave (½) or quarter-wave (¼) plate, a positive C-plate, a negative C-plate, a positive A-plate, a negative A-plate, and a biaxial plate.

The protective film may be a polymer resin film comprising a pressure-sensitive adhesive (PSA) layer on at least one surface thereof, or a self-adhesive film such as polypropylene, which may be used for protection of the touch sensor surface or improvement of processibility.

The touch sensor 120 may be a capacitive type touch sensor manufactured by a conventional method, and the configuration thereof is not particularly limited herein.

The touch sensor 120 may be formed directly on the flexible film substrate 110, or transferred to the flexible film substrate 110 after it is formed on a carrier substrate. When the touch sensor 120 is attached to the flexible film substrate 110, there may be an adhesive layer or a pressure sensitive adhesive layer (not shown) between the touch sensor 120 and the flexible film substrate 110.

The adhesive layer 130 between the touch sensor 120 and the polarizer 140 may be made of, for example, a pressure sensitive adhesive (PSA), optically clear adhesive (OCA), or optically clear resin (OCR), however, it is not limited thereto.

As the polarizer 140, a known one used in a display device can be used.

Specifically, polyvinyl alcohol (PVA), triacetyl cellulose (TAC) or cycloolefin polymer (COP) films can be used, but the present invention is not limited thereto.

According to one embodiment of the present invention, such-configured touch sensor panel 100 is cut by pinnacle cutting. At this time, the cutting direction is a direction from the flexible film substrate 110 toward the touch sensor 120 as shown in FIG. 1. The knife 200 is inserted perpendicularly to the outer surface of the flexible film substrate 110, and the blade portion of the knife has an angle α of 30 to 45 degrees.

The cutting speed can be set to 50 mm/s to 150 mm/s.

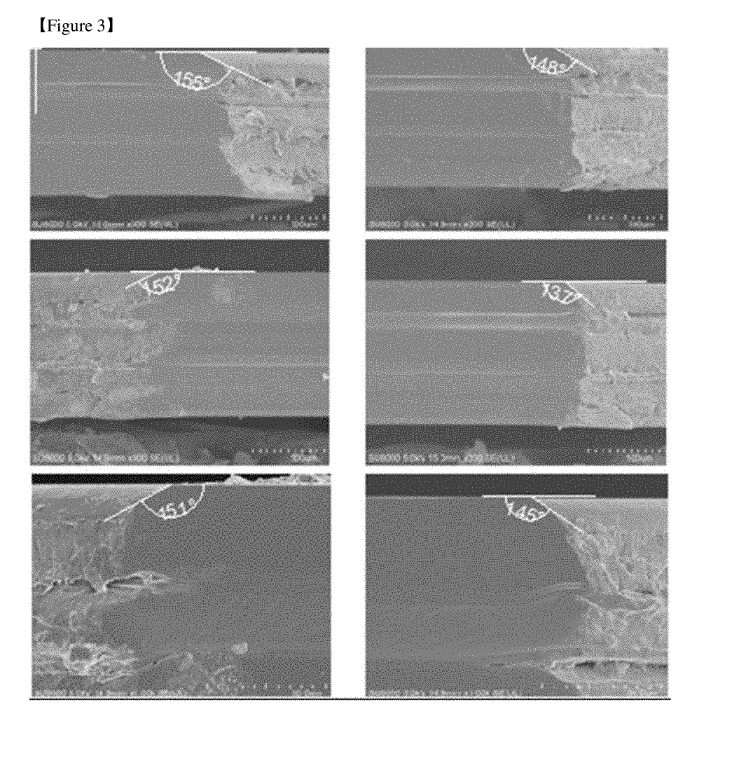

FIG. 2 is a SEM image of the touch sensor panel which has been cut according to one embodiment of the present invention.

As explained with reference to FIG. 1, the touch sensor panel is cut by inserting a knife 200 having a blade portion having an angle of 30 to 45 degrees in the direction from the flexible film substrate 110 toward the touch sensor 120. As a result, when the cross section of the cut portion is enlarged 300 times or more, the interior angle θ between the outer surface of the flexible film substrate 110, that is the upper surface of the flexible film substrate 110 and the cut portion in FIG. 2 is 90 to 170 degrees, and a smooth cut surface free from cracks of the flexible film substrate and peeling of the adhesive layer can be obtained.

Hereinafter, experimental examples and comparative examples for explaining the effect of the cutting method according to one embodiment of the present invention will be described.

FIG. 3 shows cross-sectional SEM images of experimental examples of the present invention in which a knife including a blade portion having an angle of 30 to 45 degrees is inserted in a direction from the flexible film substrate toward the touch sensor.

In FIG. 3, the upper four images are 300-fold enlarged images, and the lower two images are 1000-fold enlarged images.

As shown in FIG. 3, the interior angles between the upper surfaces of the flexible film substrates and the cut portions were 155°, 148°, 152°, 137°, 151° and 145° from top left to bottom right, respectively, and it can be seen that there are no crack of the flexible film substrates or peeling of the adhesive layers.

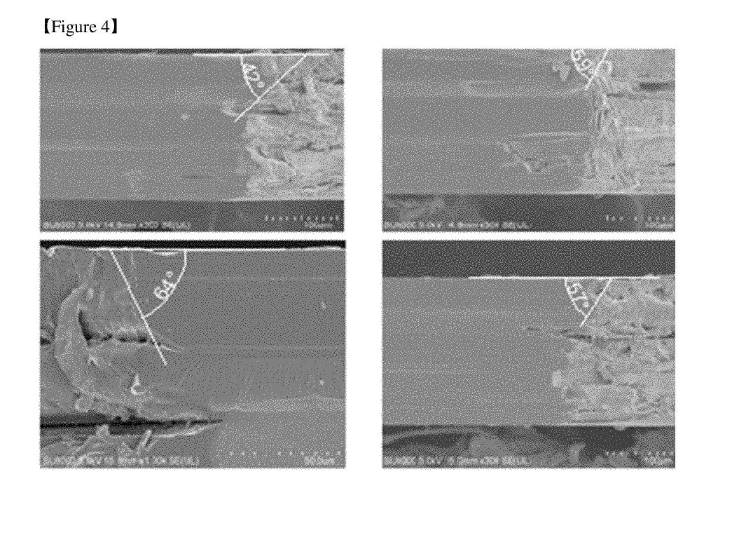

FIG. 4 shows cross-sectional SEM images of comparative examples in which a knife is inserted in a direction from the polarizer toward the touch sensor, as opposed to the embodiment of the present invention. In FIG. 4, the lower left image is a 1000-fold enlarged image, and the remaining images are 300-fold enlarged images.

As shown in FIG. 4, in the case of comparative examples, the interior angles between the upper surfaces of the flexible film substrates and the cut portions were 42°, 59°, 64° and 57°, respectively. Also, the upper surfaces of the flexible film substrates were not smooth, and peelings of the adhesive layers were observed.

Although particular embodiments and examples of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

[Description of reference numerals]
100: touch sensor panel
110: flexible film substrate
120: touch sensor
130: adhesive layer
140: polarizer
200: knife

1. A polarizer integrated touch sensor panel comprising:
a touch sensor;
a flexible film substrate disposed on a first side of the touch sensor; and
a polarizer disposed on a second side of the touch sensor opposing the first side, wherein, when a cut portion of the polarizer integrated touch sensor panel is enlarged 300 times or more, an interior angle between an outer surface of the flexible film substrate and the cut portion is 90 to 170 degrees.

2. The polarizer integrated touch sensor panel of claim 1, further comprising an adhesive layer between the touch sensor and the polarizer.

3. The polarizer integrated touch sensor panel of claim 2, wherein the adhesive layer is made of a pressure sensitive adhesive (PSA).

4. The polarizer integrated touch sensor panel of claim 1, further comprising an adhesive layer or a pressure sensitive adhesive layer between the touch sensor and the flexible film substrate.

5. A method of cutting a polarizer integrated touch sensor panel comprising:
a touch sensor;
a flexible film substrate disposed on a first side of the touch sensor; and
a polarizer disposed on a second side of the touch sensor opposing the first side, wherein cutting is performed by inserting a knife in a direction from the flexible film substrate toward the touch sensor.

6. The method of claim 5, wherein the knife is inserted perpendicularly to an outer surface of the flexible film substrate.

7. The method of claim 5, wherein the knife is formed to have a blade portion having an angle of 30 to 45 degrees.
